(19) United States
(12) Patent Application Publication
(10) Pub. No.: US 2008/0181237 A1
(43) Pub. Date: Jul. 31, 2008

(54) BUILDING COMMUNITIES OF INTEREST AND SELECTING BORDERS BETWEEN THEM BASED ON RELATIVE MOTION

(75) Inventor: Billy G. Moon, Cary, NC (US)

Correspondence Address: CISCO SYSTEMS, INC.;SCIENTIFIC-ATLANTA, INC., SA/CISCO IP DEPT., 5030 SUGARLOAF PARKWAY, LAWRENCEVILLE, GA, 30044, US

(73) Assignee: CISCO TECHNOLOGY, INC., San Jose, CA (US)

(21) Appl. No.: 11/626,932

(22) Filed: Jan. 25, 2007

(51) Int. Cl. H04L 12/28

(52) U.S. Cl. 370/400

(57) ABSTRACT

Methods and apparatus for dynamically designating communities of interest and selecting border nodes using a relative motion calculus within a mobile network are disclosed. According to one aspect of the present invention, a primary node within a mobile network identifies a first subset of nodes and logic that identifies a second subset of nodes. The primary node also identifies a first border node of the first subset, and identifies a second border node of the second subset. The first border node has a first relative motion path over a predetermined time interval, and is associated with a first pairing between the first subset and the second subset. The second border node is associated with the first pairing and has a second relative motion path over the predetermined time interval that is similar to the first relative motion path.

### BACKGROUND OF THE INVENTION

The present invention relates generally to mobile networks. More particularly, the present invention relates to a mobile network in which communities of interest each include at least one border node and are defined using a relative motion calculus such that standard routing protocols may be used to dynamically converge the mobile network.

As the use of mobile networks such as mobile ad hoc networks increases, the need to support mobile devices that are Internet Protocol (IP) based is becoming more prevalent. Within a mobile network, nodes that are in communication using wireless links may move randomly. Hence, the overall topology of a wireless mobile network may change frequently.

Typically, networks designate borders or border nodes for groups that may communicate with each other. A first border, or a device in a first peer group in a network, may communicate with a second border, or a device in a peer group of the network, to exchange information between the first and second peer groups. A border generally has links to nodes in its peer group, as well as at least one link to another peer group, e.g., at least one link that effectively crosses the boundary of its peer group. In general, border nodes are static. That is, once a border node is designated for a group, that border node remains as the only border node for the group.

In a mobile network, a group of nodes may include nodes that are moving together. The designated border node is responsible for keeping track of the location of substantially all nodes in the group, and for acting as the liaison for the group relative to other groups. The same node within a group is designated as the border node without regard to the orientation of the nodes within the group. That is, the border node is statically designated.

At times, the designated border node within a mobile group may not be able to efficiently communicate with other nodes in the mobile group, or with other groups. By way of example, the designated border node may not be near the boundary of its mobile group and, hence, may not be in the communications range of a neighboring group. As a result, the mobile group may not be able to communicate with the neighboring group.

Therefore, what is needed is a method and an apparatus which allows border nodes to be dynamically designated. That is, what is desired is a system within which a group may have at least one border node that is dynamically selected based upon the relative motion of the group.

### BRIEF DESCRIPTION OF THE DRAWINGS

The invention may best be understood by reference to the following description taken in conjunction with the accompanying drawings in which:

FIG. 1A is a diagrammatic representation of a mobile network in which nodes are divided into a first set of subsets or communities of interest at a time t1 based on a relative motion calculus in accordance with an embodiment of the present invention.

FIG. 1B is a diagrammatic representation of a mobile network, i.e., mobile network 100 of FIG. 1A, in which the first set of subsets each include at least one border node at a time t1 in accordance with an embodiment of the present invention.

FIG. 1C is a diagrammatic representation of a mobile network, i.e., mobile network 100 of FIG. 1A, in which the first set of subsets each include at least one border node at a time t2 that is after time t1 in accordance with one embodiment of the present invention.

FIG. 1D is a diagrammatic representation of a mobile network, i.e., mobile network 100 of FIG. 1A, in which a second set of subsets each include at least one border node at a time t2 that is after time t1 in accordance with another embodiment of the present invention.

FIG. 2 is a process flow diagram which illustrates a method of establishing communications within a mobile network in accordance with an embodiment of the present invention.

FIG. 3 is a block diagram representation of a border node in accordance with an embodiment of the present invention.

FIG. 4 is a block diagram representation of a mobile router, e.g., a border router, in accordance with an embodiment of the present invention.

FIG. 5 is a process flow diagram which illustrates a method of selecting border nodes in accordance with an embodiment of the present invention.

### DESCRIPTION OF THE EXAMPLE EMBODIMENTS

### General Overview

In one embodiment, a primary node within a mobile network includes logic that identifies a first subset of nodes and logic that identifies a second subset of nodes. The primary node identifies a first border node of the first subset, and identifies a second border node of the second subset. The first border node has a first relative motion path over a predetermined time interval, and is associated with a first pairing between the first subset and the second subset. The second border node is associated with the first pairing and has a second relative motion path over the predetermined time interval that is similar to the first relative motion path.

### Description

Within a mobile network such as a mobile ad hoc network, nodes may be dynamically allocated into subsets or communities of interest based on a relative motion calculus. By using information relating to the relative motion, e.g., directional velocity and acceleration, of nodes in a mobile ad hoc network, nodes that are likely to remain in contact with each other during a time interval may be allocated to a subset or community of interest. Once a community of interest within a mobile ad hoc network is established, the community of interest may be mapped to an area or a zone that may be used to enable routing protocols to attempt convergence among the nodes contained in the community of interest.

Border nodes for each pairing of communities of interest may be dynamically selected. The border nodes each effectively collect information associated with each node in their respective communities of interest, and act as gateways between the communities of interest such that a node in one community of interest may communicate with a node in another community of interest using border nodes associated with the two communities of interest. Such border nodes may include summaries of substantially all nodes within their respective communities of interest, and also identify border nodes with which they may communicate. In one embodiment, border nodes may store the summaries in wide area routing tables that may be used by routing protocols to determine routes over which packets may be sent.

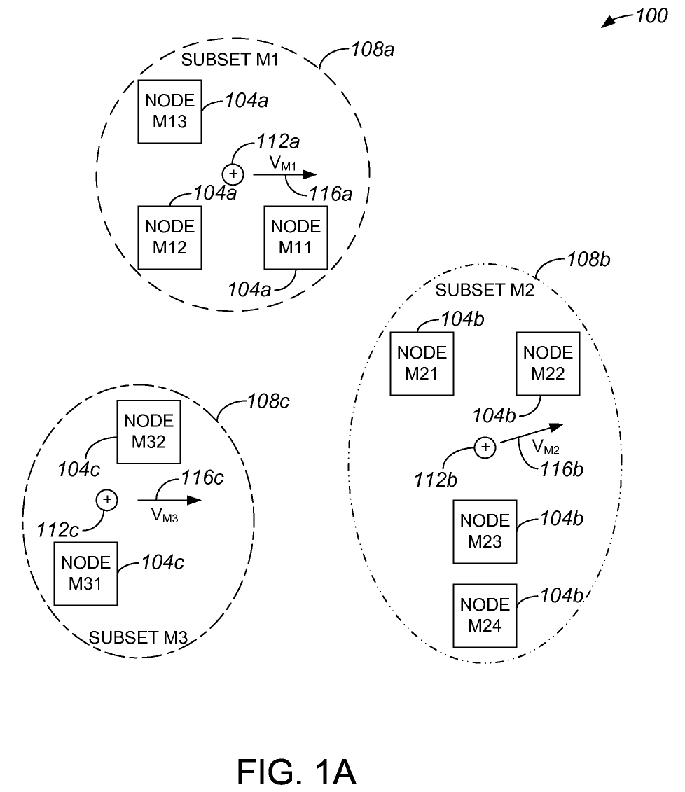

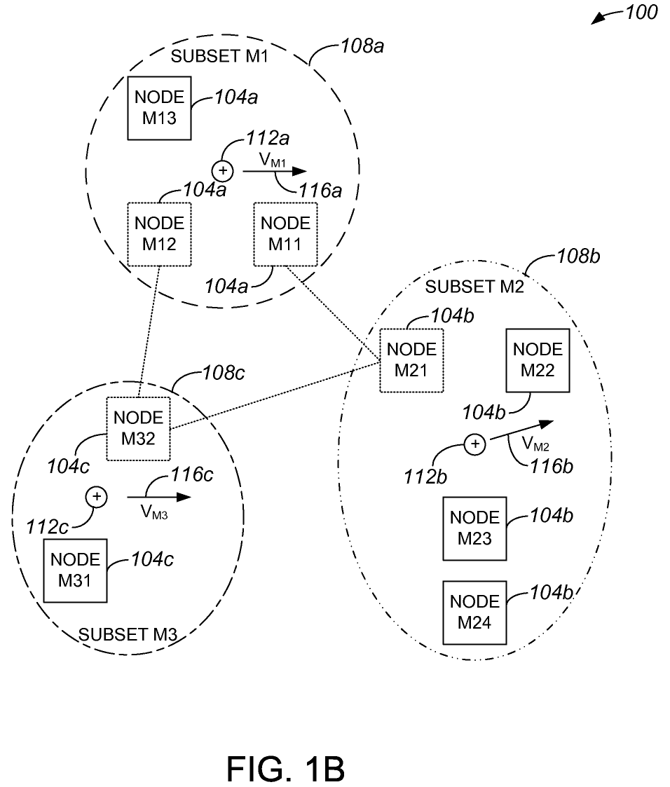

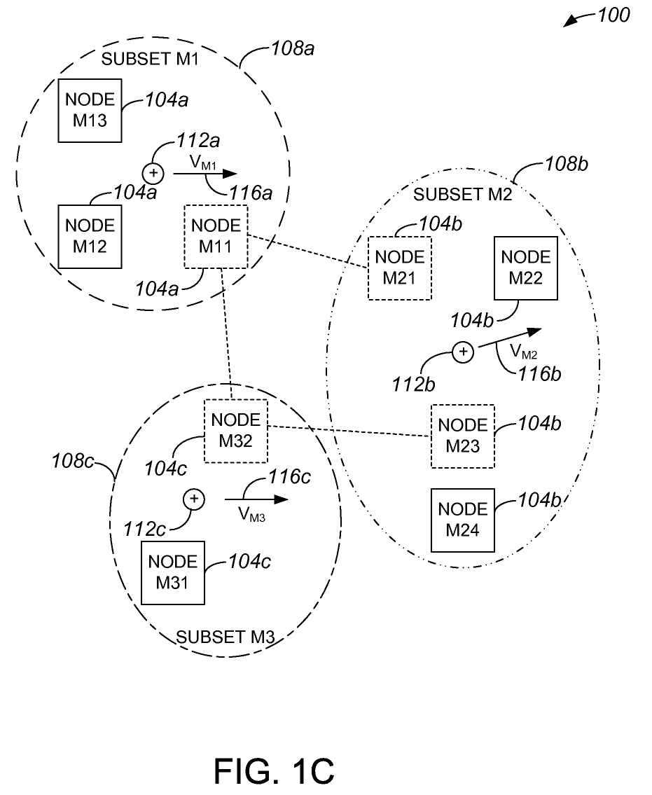

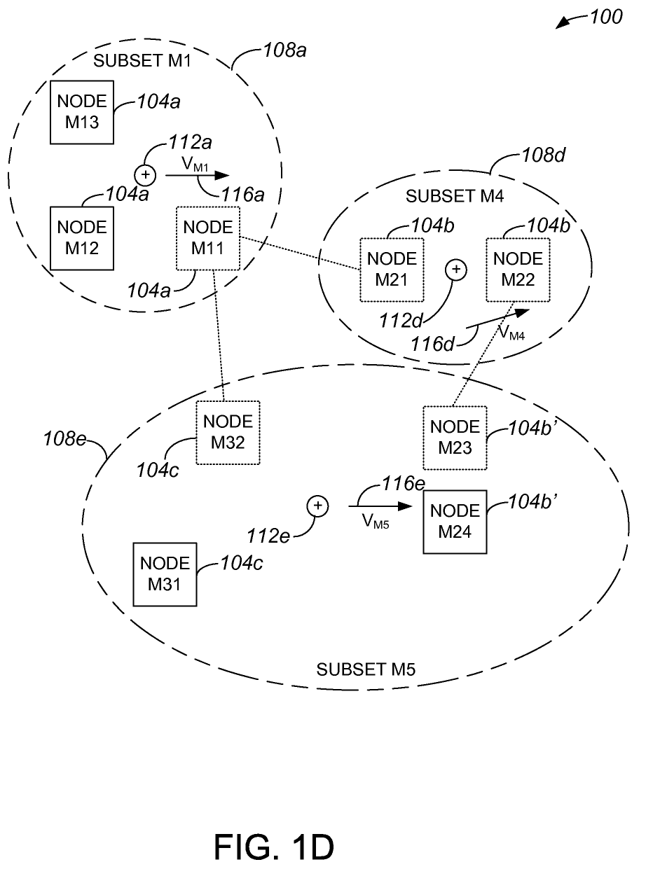

FIG. 1A is a diagrammatic representation of a mobile network in which nodes are divided into a first set of subsets or communities of interest at a time t1 based on a relative motion calculus in accordance with an embodiment of the present invention. At a point in time t1, a mobile ad hoc network 100 is divided into a plurality of subsets or communities of interest 108a-c using a relative motion calculus. Geospatial information associated with nodes 104a-c may be used to determine the relative motion of nodes 104a-c, e.g., the relative motion of some nodes 104a-c relative to a given node 104a-c. One relative motion calculus is described in co-pending U.S. patent application Ser. No. 11/494,584, filed Jul. 28, 2006 (Atty. Docket No. CPOL 933678/10-069), which is incorporated herein by reference in its entirety.

Nodes 104a-c typically each have at least one local area network (LAN) and wide area network (WAN) wireless interface for internet protocol (IP) based communications. In addition, nodes 104a-c generally also include routing resources that enable information to be shared between nodes 104a-c, e.g., routing resources that allow IP-based packets to be exchanged. Nodes 104a-c may be arranged to understand metrics that are associated with Open Systems Interconnection (OSI) layer 2 and layer 1. Nodes 104a-c may use location information to determine how to route packets, and may include mobile routers. At least one node 104a-c within network 100 is arranged to determine the proximity of nodes 104a-c relative to one another, and to determine subsets 108a-c.

Subsets 108a-c may be selected based upon the relative location of nodes 108a-c, as well as a directional velocity associated with nodes 108a-c. By way of example, nodes 104a may be determined to be in proximity to each other, and may have approximately the same directional velocity. In one embodiment, nodes 104a may be part of a convoy or a group that is moving or otherwise traveling together. Hence, nodes 104a are considered as being a part of a subset M1 108a that has an approximate overall temporary geospatial location 112a and is moving at an approximate velocity V_{M1} 116a. In one embodiment, approximate velocity V_{M1} 116a may be determined by comparing a previous overall geospatial location at a previous time to location 112a at time t1. That is, a direction and an approximate velocity V_{M1} 116a may be estimated if locations of nodes 104a over time is known. Similarly, nodes 104b are a part of a subset M2 108b that has an approximate overall temporary geospatial location 112b and is moving at an approximate velocity V_{M2} 116b, while nodes 104c are a part of a subset M3 108c that has an approximate overall temporary geospatial location 112c and is moving at an approximate velocity V_{M2} 116b.

Each subset 108a-c may have at least one border node, or node that maintains information pertaining to every other node 104a-c within its subset 108a-c. Hence, at least one border node in subset 108a may provide information relating to substantially all nodes 108a to subsets 108b, 108c. Each border node within a subset 108a-c is arranged to effectively publish an indication of which subset 108a-c the border node has access to. In one embodiment, border nodes may be identified by any nodes 104a-c. With reference to FIG. 1B, the identification of at least one border node for each subset 108a-c at a time t1 will be described in accordance with an embodiment of the present invention. Each subset 108a-c may have one of more nodes 104a-c that are designated as border nodes. Node M12 104a is a border node in subset M1 108a that has access to subset M3 108c. Node M32 104c of subset M3 108c is a border node that has access to subset M1 108a and subset M2 108b. Node M1 104a is a border node in subset M1 108a that has access to subset M2 108b, while node M21 104b is a border node in subset M2 108b that has access to subset M1 108a and subset M3 108c. As such, subset M1 108a has two border nodes, i.e., border node M11 104a and border node M12 104a, while subset M2 108b and subset M3 108c each have one border node.

In one embodiment, a border node within one subset 108a-c may be selected based on the proximity of the selected border node to a node 104a-c in another subset 108a-c, as well as the similarity between the directional velocity of the selected border node and the directional velocity of the node 104a-c in proximity to the selected border node. For example, node M12 104a may be a border node in subset M1 108a that is paired with subset M3 108c because node M12 104a and node M32 104c are in proximity to one another and also have similar directional velocities. As node M11 104a may not be closer proximity to nodes 104b than node M11 104a may be, node M11 104a may be selected as a border node in subset M1 108a that is paired with subset M2 108b.

Border nodes generally facilitate the exchange of information, e.g., location information, between subsets 108a-c. By way of example, if a node 104a within subset M1 108a wishes to identify where subset M2 108b is currently located, node 104a may obtain location information regarding subset M2 108b through border node M11 104a, which exchanges information with subset M2 108b through border node M21 104b.

The assignment or designation of border nodes within subset 108a-c may vary with time. If subsets 108a-c move relative to each other, the assignment of border nodes within subsets 108a-c as shown in FIG. 1B may effectively be outdated, as the positioning of nodes 104a-c in one subset 108a-c relative to nodes 104a-c in another subset 108a-c may have shifted. FIG. 1C is a diagrammatic representation network 100 at a time t2 that is after time t1 in accordance with one embodiment of the present invention. As shown, at a time t2, nodes 104a are still grouped in subset M1 108a, nodes 104b are still grouped in subset M2 108b, and nodes 104c are still grouped in subset M3 108c. However, as node M11 104a is closer in proximity to nodes 104b in subset M2 108b and nodes 104c in subset 108c than other nodes 104a, node M11 104a is a border node in subset M1 108a that has access to subset M2 108b and subset M3 108c. Node M21 104c of subset M3 108c is still a border node at time t2, but node M21 104c has access to subset M1 108a through node M11 104a, and access to subset M2 108b

Node M21 104b, which was a border node in subset M2 108b at time t1, is still a border node at time t2. However, node M21 104b is a border node for subset M1 108a at time t2, and not a border node for subset M3 108c. Instead, subset M2 108b has two border nodes at time t2, namely node M21 104b which exchanges information with subset M1 108a and node M23 104b which exchanges information with subset M3 108c.

In addition to reassigning or redesignating border nodes at a time t2, subsets within network 100 may also be reassigned. That is, network 100 may be regrouped into subsets at a time t2, and border nodes may be assigned in the new subsets. In one embodiment, subsets may be regrouped if it is determined that different groupings of nodes are likely to stay in contact with each other in a time interval that begins at time t2 than those specified at time t1. FIG. 1D is a diagrammatic representation of network 100 in which a subsets and border nodes are effectively redesignated at a time t2 in accordance with another embodiment of the present invention. A subset M1 108a is determined to remain in tact, as nodes 104a remain in proximity to each other, and have approximately the same directional velocity. A new subset M4 108d is defined to include node M21 104b and node M22 104b, if it is determined that node M21 104b and node M22 104b are in relatively close proximity to each other, and have approximately the same directional velocity. Subset M4 108d may have an approximate location 112d, and may be moving at a directional velocity V_{M4} 116d.

Node M23 104b′ and node M24 104b′ may be closer in proximity to nodes 104c at time t2 than to node M21 104b and node M22 104b. Hence, node M23 104b′ and node M24 104b′ may be grouped with nodes 104c into a subset M5 108e that has an approximate location 112e and a directional velocity V_{M5} 116e.

Within subset M5 108e, nodes M32 104c may be determined to be a border node that has access to subset M1 108a, while node M23 104b′ may be identified as a border node that has access to subset M4 104b. Subset M4 108d may designate node M21 104b as a border node with access to subset M1 108a, and node M22 104b as a border node with access to subset M4 108d.

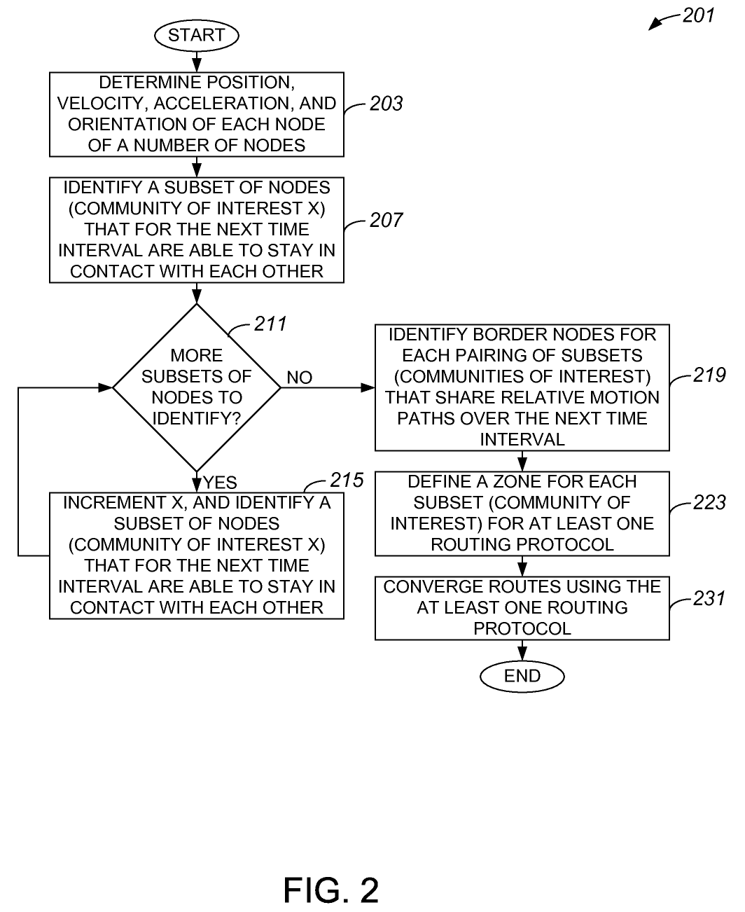

Referring next to FIG. 2, the steps associated with one method of establishing subsets or communities of interest with border nodes within a mobile ad hoc network using a relative motion calculus will be described in accordance with an embodiment of the present invention. A process 201 of establishing at least one community of interest with a border node begins at step 203 in which the position, velocity, acceleration, and orientation of each node of a number of nodes is determined. The number of nodes may vary widely, and may include every node that is associated with a mobile ad hoc network.

After the position, velocity, acceleration, and orientation of each node is determined, a first subset of nodes, i.e., a first community of interest, is identified in step 207. The first subset of nodes may be nodes that will be able to stay in contact with one another during the next time interval. The length of a time interval may vary, depending upon the requirements of the overall system. In addition, a time interval may be a predetermined length of time, or may be a length of time that varies depending upon the transient characteristics within the overall system. The first subset of nodes may be identified using relative proximity and relative stability information, as well as mobility metrics, as described in co-pending U.S. patent application Ser. No. 11/494,584, filed Jul. 28, 2006, which is incorporated herein by reference in its entirety. The information is generally received by mobile routers using neighbor discovery messages, and may include, but is not limited to including, position coordinates, velocity information, and link speeds. Hence, mobile routers within the mobile ad hoc network identify the first subset of nodes.

Once the first subset of nodes is identified, it is determined in step 211 if there are more subsets of nodes to identify. That is, it is determined if there are additional communities of interest associated with the mobile ad hoc network. Typically, there are a plurality of subsets in a mobile ad hoc network. If it is determined that there are more subsets of nodes to identify, process flow moves to step 215 in which another subset of nodes is identified. The subset of nodes identified in step 215 is a group of nodes that, for the next time interval, are able to stay in contact with each other. After the subset of nodes is identified, process flow returns to step 211 in which it is determined if there are additional subsets to identify.

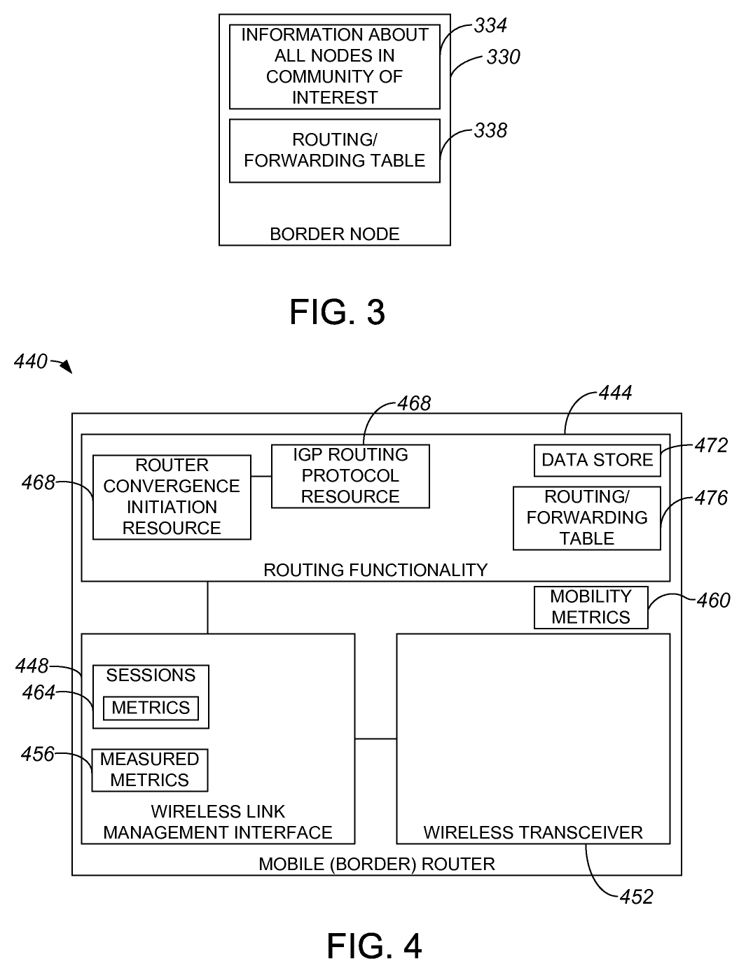

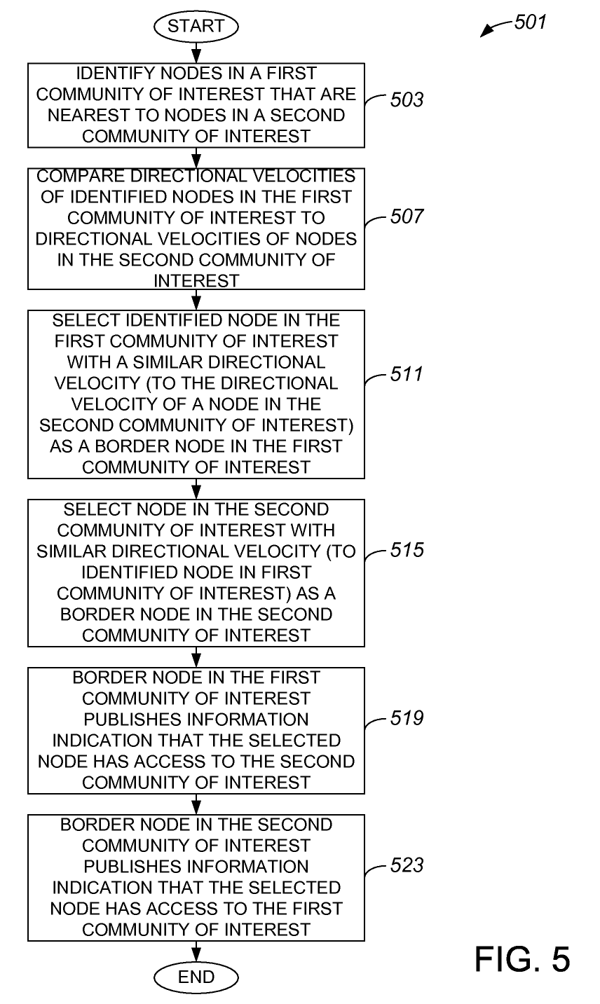

Alternatively, if it is determined in step 211 that there are no more subsets of nodes to identify, border nodes for each pairing of subsets is identified in step 219. By way of example, a node in a first community of interest and a node in a second community of interest that share, or are anticipated to share, relative motion paths over the next time interval may be identified as border nodes. A particular subset may have different border nodes associated with each pairing of subsets that the particular subset is included in. For instance, a first node of a first subset may be a border node for a pairing that includes a second subset, and a second node of the first subset may be a border node for a pairing that includes a third subset. One example of a border node will be described below with reference to FIG. 3. The steps associated with one method of identifying border nodes will be discussed below with respect to FIG. 5.

Once border nodes are identified, an area or a zone for each subset is defined for at least one routing protocol in step 223. In other words, for each routing protocol that may be used within the mobile ad hoc network, an area or zone that is to be covered by the subset is defined. Defining an area or zone allows a routing protocol to converge routes substantially within the area or zone. Routing protocols may include, but are not limited to, interior gateway protocol (IGP), enhanced interior gateway routing protocol (EIGRP), open shortest path first (OSPF), and intermediate system to intermediate system (IS-IS).

In step 231, the at least one routing protocol is used by the border node, which includes a border router, to dynamically converge routes in step 231. That is, any routing protocol that may be used within the mobile ad hoc network is triggered to initiate a convergence of network routes. The areas or zones defined in step 223 effectively define areas in which routes are to be converged within each subset. Hence, for each subset that has a defined area, a routing protocol triggered within a border node of that subset may effectively attempt to converge routes associated with the nodes in that subset. Thus, each border node may implement routing protocols that may be used to converge network routes for their associated subsets within a mobile network. The process of establishing subsets or communities of interest with border nodes within a mobile ad hoc network is completed once routes are converged.

FIG. 3 is a block diagram representation of a border node in accordance with an embodiment of the present invention. A border node 330 generally stores information 334, e.g., information about substantially all nodes in a subset or a community of interest in which border node 330 is a member. Border node 330 also includes a routing or forwarding table 338 that contains information pertaining to how a packet may be routed through border node 330 to an intended destination.

As previously mentioned, a border router is defined or otherwise identified for each border node in a subset or a community of interest. In the described embodiment, each border node may be a border router. Referring next to FIG. 4, a mobile router that may be a border router will be described in accordance with an embodiment of the present invention. A router 440 includes routing functionality 444, a wireless link management interface 448, and a wireless transceiver 452. Routing functionality 444 may be implemented to include a router convergence initiation resource 468 that initiates the converging of paths. Router convergence initiation resource 468 utilizes information, e.g., mobility metrics 460 and session metrics 464, of links to quantify the relative distances as a measure of the stability of the links. Routing functionality 444 also includes a IGP routing protocol resource 468 that is arranged to populate a data store 472, e.g., a database, based on neighbor discover protocols, and to exchange information with neighboring nodes based on the at least one routing protocol. IGP routing protocol resource 468 implements convergence of at least one routing protocol, and populates a routing/forwarding table 476 when a command from router convergence initiation resource 468 is received.

Wireless link management interface 448 provides OSI layer 2 management functionality, and establishes links with nodes within a mobile network. For example, wireless link management interface 448 controls the flow between router 440 and nodes within a mobile network, via wireless transceiver 452. In one embodiment, if wireless link management interface 448 is coupled to wireless transceiver 452 using a wired connection such as a one Gigabit Ethernet link, wireless link management interface 448 establishes a session 448 for each node with which router 440 has a connection, e.g., a wireless connection or link. Sessions 448 may be point-to-point over Ethernet (PPPoE) sessions that have flow control credits and link metrics 464. Typically, sessions 448 receive packets such as packets associated with neighbor discovery messages.

Wireless link management interface 448 includes measured metrics 456 that are detected by router 440. Such metrics 456 may include received signal strength indicators, radar measurements, and values that may be obtained using physical sensors (not shown) associated with router 440. Metrics 464 associated with sessions 448 are generally obtained from received packets. Such metrics 464 may include, but are not limited to, physical attributes such as position attributes, velocity attributes, acceleration attributes. Mobility metrics 460 may include information associated with a vehicle or moving platform that effectively carries router 440. Hence, mobility metrics 460 may include position, orientation velocity, or acceleration information.

Wireless transceiver 452 is arranged to transmit and to receive packets. In general, wireless transceiver 452 establishes wireless connections or links with nodes within a mobile network.

With reference to FIG. 5, one method of selecting and configuring border nodes will be described in accordance with an embodiment of the present invention. In one embodiment, a process of selecting border nodes or routers is distributed amongst nodes in a system. That is, each node in a system may select and configure border nodes. By way of example, if a node in one community of interest finds a corresponding “mate” in a neighboring community of interest, the paring between the node and its mate may elect to become a border between the two communities. A method 501 of selecting and configuring border nodes begins at step 503 in which nodes in a first subset or community of interest that are nearest, e.g., physically nearest, to nodes in a second subset or community of interest are identified. Such an identification may be made based on position coordinates, directional velocity, and other information that may be contained in a neighbor discovery message.

Once nodes are identified, the directional velocities of the identified nodes are compared in step 507 to the directional velocities of nodes in the second community of interest. Then, in step 511, one of the identified nodes is selected from the first community of interest as a border node in the first community of interest for a pairing between the first community of interest and the second community of interest. The directional velocity of the selected node, in one embodiment, is approximately the same as or is at least similar to the directional velocity of a node in the second community of interest.

After a border node in the first community of interest is selected for the pairing between the first community of interest and the second community of interest, the node in the second community or interest that has a similar directional velocity to the border node in the first community of interest is selected in step 515 as a border node in the second community of interest. That is, the node in the second community of interest with approximately the same directional velocity as the border node in the first community of interest is selected as a border node in the second community of interest for the pairing between the first community of interest and the second community of interest.

The border node in the first community of interest publishes information in step 519 that indicates that the border node in the first community of interest has access to the second community of interest. Similarly, in step 523, the border node in the second community of interest publishes information that indicates that the border node in the second community of interest has access to the first community of interest. Once information is published by the border nodes, the process of selecting and configuring border nodes is completed.

Although only a few embodiments of the present invention have been described, it should be understood that the present invention may be embodied in many other specific forms without departing from the spirit or the scope of the present invention. By way of example, while subsets or communities of interest of nodes within a mobile network have generally been described as being grouped based at least in part on an ability of the nodes in a subset to remain in contact with each other, subsets may be grouped based on other criteria. In other words, subsets are not limited to being defined based on the ability of nodes within a subset to remain in contact with one another over a time interval.

Nodes within a mobile network may generally be mobile elements, and may include autonomous devices such as robots, and drones. Typically, nodes are devices which may establish communications links with other devices. In one embodiment, a node within a mobile network may be a substantially stationary node, e.g., a static node that the mobile network encompasses during a particular time interval.

While border nodes on both sides of a pairing, i.e., a pairing of two subsets or communities of interest, have been described as being selected based upon having similar velocities, it should be appreciated that border nodes may instead be selected based on other factors. Further, nodes with similar velocities that are selected to be border nodes may be the two nodes with velocities that are closest in at least one of magnitude or direction. In other words, similar velocities are not limited to being velocities that are approximately equal, and may be velocities that are closest to each other in terms of magnitude and/or direction.

A node within a mobile network may include logic, code devices, or executable code devices that are arranged to implement the present invention. By way of example, software logic or hardware logic of a node may be arranged to identify at least one community of interest and at least one border node. Software logic may generally be embodied on a computer readable medium such as a memory or may be propagated via a computer readable medium such as a wireless transmission medium as a data signal embodied in a carrier wave.

The steps associated with the methods of the present invention may vary widely. Steps may be added, removed, altered, combined, and reordered without departing from the spirit of the scope of the present invention. Therefore, the present examples are to be considered as illustrative and not restrictive, and the invention is not to be limited to the details given herein, but may be modified within the scope of the appended claims.

What is claimed is:

1. Logic encoded in one or more tangible media for execution and when executed operable to:
identify a first subset of a plurality of nodes;
identify a second subset of the plurality of nodes;
identify a first border node of the first subset, the first border node having a first relative motion path over a predetermined time interval, the first border node being associated with a first pairing between the first subset and the second subset; and
identify a second border node of the second subset, the second border node having a second relative motion path over the predetermined time interval, the second border node being associated with the first pairing, wherein the first relative motion path and the second relative motion path approximately share at least one characteristic.

2. The logic of claim 1 further operable to:
define a first area, the first area being associated with the first subset, wherein the first area is defined for a first routing protocol;
identify a first border router; and
triggers the first border router to converge routes within the first area.

3. The logic of claim 2 wherein the first routing protocol is one selected from a group including an enhanced interior gateway routing protocol (EIGRP), an open shortest path first (OSPF) routing protocol, and intermediate system to intermediate system (IS-IS) routing protocol.

4. The logic of claim 1 wherein the primary node is a mobile router.

5. The logic of claim 1 further operable to:
determine at least one selected from the group including position, velocity, acceleration, and orientation for each node in the plurality of nodes, wherein determining the at least one selected from the group including position, velocity, acceleration, and orientation for each node in the plurality of nodes includes determining the first relative motion path and logic that determines the second relative motion path.

6. The logic of claim 1 wherein nodes included in the first subset are arranged to have first directional velocities that are approximately the same, and nodes included in the second subset are arranged to have second directional velocities that are approximately the same.

7. The logic of claim 1 further operable to:
identify a third subset of the plurality of nodes;
identify a third border node of the third subset, the third border node having a third relative motion path over the time interval, the third border node being associated with a second pairing between the first subset and the third subset; and
identify a fourth border node of the first subset, the fourth border node having a fourth relative motion path over the time interval, the fourth border node being associated with the second pairing, wherein the third relative motion path and the fourth relative motion path are similar.

8. The logic of claim 7 further operable to:
identify a fifth border node of the third subset, the fifth border node having a fifth relative motion path over the time interval, the fifth border node being associated with a third pairing between the second subset and the third subset; and
identify a sixth border node of the second subset, the sixth border node having a sixth relative motion path over the time interval, the sixth border node being associated with the third pairing, wherein the fifth relative motion path and the sixth relative motion path are similar.

9. The logic of claim 1 further operable to:
identify a third subset of the plurality of nodes; and
identify a third border node of the third subset, the third border node having a third relative motion path over the time interval, the third border node being associated with a second pairing between the first subset and the third subset, wherein the third relative motion path and the first relative motion path are similar, the first border node further being associated with the second pairing.

10. A primary node, the primary node being included in a plurality of nodes within a mobile network, the primary node comprising:
means for identifying a first subset of the plurality of nodes;
means for identifying a second subset of the plurality of nodes;
means for identifying a first border node of the first subset, the first border node having a first relative motion path over a predetermined time interval, the first border node being associated with a first pairing between the first subset and the second subset; and
means for identifying a second border node of the second subset, the second border node having a second relative motion path over the predetermined time interval, the second border node being associated with the first pairing, wherein the first relative motion path and the second relative motion path approximately share at least one characteristic.

11. A method comprising:
dynamically building a first community of interest, the first community of interest including a first plurality of nodes included in a mobile network, wherein each node of the first plurality of nodes is capable of contacting every other node of the first plurality of nodes during a predetermined time interval;
dynamically building a second community of interest, the second community of interest including a second plurality of nodes included in the mobile network, wherein each node of the second plurality of nodes is capable of contacting every other node of the second plurality of nodes during the predetermined time interval;
selecting a first border node of the first community of interest for a first pairing of the first community of interest and the second community of interest, the first border node being arranged to include information about each node of the first plurality of nodes, wherein the first border node has a first relative motion path; and
selecting a second border node of the second community of interest for the first pairing, the second border node being arranged to include information about each node of the second plurality of nodes, wherein the second border node has a second relative motion path that approximately shares a characteristic with the first relative motion path.

12. The method of claim 11 further including:
defining a first area associated with the first community of interest; and
triggering a routing protocol to converge routes for the first community of interest within the first area.

13. The method of claim 12 further including:
associating a mobile router with the first border node, wherein the routing protocol is triggered within the mobile router.

14. The method of claim 12 wherein the routing protocol is one selected from a group including an enhanced interior gateway routing protocol (EIGRP), an open shortest path first (OSPF) routing protocol, and intermediate system to intermediate system (IS-IS) routing protocol.

15. The method of claim 11 wherein the first border node is arranged to exchange information with the second border node.

16. The method of claim 11 further including:
dynamically building a third community of interest, the third community of interest including a third plurality of nodes included in the mobile network, wherein each node of the third plurality of nodes is capable of contacting every other node of the third plurality of nodes during the time interval;
selecting a third border node of the third community of interest for a second pairing of the first community of interest and the third community of interest, the third border node being arranged to include information about each node of the third plurality of nodes, wherein the third border node has a third relative motion path; and
selecting a fourth border node of the first community of interest for the second pairing, the fourth border node being arranged to include information about each node of the first plurality of nodes, wherein the fourth border node has a fourth relative motion path that is similar to the third relative motion path.

17. Logic encoded in one or more tangible media for execution and when executed operable to:
dynamically build a first community of interest, the first community of interest being a subset of nodes within the mobile network, each node of the subset of nodes being arranged to remain in contact with every other node of the subset of nodes over a time interval; and
designate a plurality of border nodes within the first community of interest, the plurality of border nodes including a first border node and a second border node, the first border node being associated with a first pairing of the first community of interest and a second community of interest within the mobile network, the second border node being associated with a second pairing of the first community of interest and a third community of interest within the mobile network.

18. The logic of claim 17 further operable to dynamically build the first community of interest by determining at least one selected from a group including position, velocity, acceleration, and orientation for each node of the subset of nodes.

19. The logic of claim 17 wherein the first border node publishes information regarding the first subset of nodes and the second border node publishes information regarding the second subset of nodes.

20. The logic of claim 17 further operable to designate the plurality of border nodes by selecting the first border node based on a first relative motion path of the first border node and selecting the second border node based on a second relative motion path of the second border node.

21. The logic of claim 17 further operable to:
identify a router associated with the first community of interest; and
initiate a convergence of paths associated with the first community of interest using the router.

22. A device within a mobile network, the device comprising:
means for dynamically building a first community of interest, the first community of interest being a subset of nodes within the mobile network, each node of the subset of nodes being arranged to remain in contact with every other node of the subset of nodes over a predetermined time interval; and
means for designating a plurality of border nodes within the first community of interest, the plurality of border nodes including a first border node and a second border node, the first border node being associated with a first pairing of the first community of interest and a second community of interest within the mobile network, the second border node being associated with a second pairing of the first community of interest and a third community of interest within the mobile network.

23. A method comprising:
dynamically building a first community of interest, the first community of interest being a subset of nodes within the mobile network, each node of the subset of nodes being arranged to remain in contact with every other node of the subset of nodes over a predetermined time interval; and
designating a plurality of border nodes within the first community of interest, the plurality of border nodes including a first border node and a second border node, the first border node being associated with a first pairing of the first community of interest and a second community of interest within the mobile network, the second border node being associated with a second pairing of the first community of interest and a third community of interest within the mobile network.

24. The method of claim 23 wherein dynamically building a first community of interest includes determining directional velocities for each node of the subset of nodes.

25. The method of claim 23 wherein dynamically building the first community of interest includes determining at least one selected from a group including position, velocity, acceleration, and orientation for each node of the subset of nodes.

26. The method of claim 23 wherein the first border node publishes information regarding the first subset of nodes and the second border node publishes information regarding the second subset of nodes.

27. The method of claim 23 wherein designating the plurality of border nodes includes:
determining a first relative motion path of the first border node; and
determining a second relative motion path of the second border node.

28. The method of claim 23 further including:
identifying a router associated with the first community of interest; and
initiating a convergence of paths associated with the first community of interest using the router.
